(19) United States
(12) Patent Application Publication
(10) Pub. No.: US 2008/0099275 A1
(43) Pub. Date: May 1, 2008

(54) Sound Attenuation Enclosure

(76) Inventor: Robert Vaughan Seel, Dublin, OH (US)

Correspondence Address: Robert L. Wolter;Beusse Brownlee Wolter Mora & Maire, P.A., Suite 2500, 390 North Orange Avenue, Orlando, FL, 32801, US

(21) Appl. No.: 11/554,785

(22) Filed: Oct. 31, 2006

(51) Int. Cl. H02K 5/24

(52) U.S. Cl. 181/202

(57) ABSTRACT

An embodiment of a sound attenuation enclosure comprises a body having a plurality of panels aligned side-by-side forming the enclosure wherein each panel abuts, and is positioned at an angle with respect to, an adjacent panel. The enclosure has a first opened end and a second opened end, and each panel is positioned in spaced relation to the body of the operating system within the enclosure. At least one aperture is formed in the enclosure through which a part of the operating system extends; and, at least one end cap is positioned over either the first end or second end of the enclosure wherein the end cap is separable from the body. The enclosure may have two end caps including a first end cap on the first end of the enclosure; and, a second end cap on the second end of the enclosure. The end caps are also positioned in spaced relation to the body portion of the enclosed operating system.

### FIELD OF THE INVENTION

This invention relates to devices used to attenuate sound emanating from mechanical or electro-mechanical operating systems where noise, sound or vibration are a consideration for the operation of such systems.

### BACKGROUND OF THE INVENTION

An ongoing problem associated with mechanical and electro-mechanical operating systems is the noise level such systems generate. With the continuous technical advances in the fields of metallurgical, electrical and mechanical engineering, manufacturers of equipment are able to minimize the physical dimensions of equipment including the thickness and mass of equipment components. These changes often result in increased noise pollution levels. Examples of such operating systems include, but are not limited to, HVAC units, pool pumps, gas manifolds, emergency storm generators and sump pumps.

Sound and improved efficiency/performance often cause conflicting results. Equipment manufacturers often are limited to installing sound blankets or lining structures with fiber wool to reduce the noise level emanating from structures. Similar principles have been adopted by the gas turbine and automotive industry using combinations of fiber, acoustic foams and composite metal combinations to address the various sound issues.

Although sound cancellation schemes have been proposed, no solution has been found to satisfactorily address the broad-spectrum noise cancellation signature of a mechanical or electro-mechanical mechanism. The sound blankets typically vinyl jacket filled with a fiberglass insulation material commonly known as R-19. The sound blankets placed over gas valves, motors, compressor and various operating systems and provide minimal sound reduction.

Such attempts to meet consumer needs have encountered manufacturing and performance issues, produced minimum reliability performance and in some cases health hazards. As an example, fiber glass/wool materials can be a nesting area for rodents. These materials also retain moisture, which causes fungal/bacteria growth. In addition, the blanket contacts the operating system, which can reduce the overall performance and life of the operating system. That is the blanket acts as an insulating jacket that generates heat. Elevated temperatures with respect to a normal operating temperature places stress on components causing the system fail. As such, there remains significant room for improvement in low cost noise abatement for electrical and mechanical systems that are exposed to the outdoor elements.

### SUMMARY OF THE INVENTION

The present invention is for an enclosure that attenuates sound emanating from an operating mechanical or electro-mechanical system having an operating body portion generating the sound and at least one input or output part connected to the body portion. The enclosure comprises a wall having a plurality of panels aligned side-by-side forming the enclosure wherein each panel abuts, and is positioned at an angle with respect to, an adjacent panel. The enclosure has a first opened end and a second opened end, and each panel is positioned in spaced relation to the body of the operating system. At least one aperture formed in the enclosure through which the part extends; and, at least one end cap positioned over either the first end or second end of the enclosure wherein the end cap is separable from the wall. The enclosure may have two end caps including a first end cap on the first end of the enclosure; and, a second end cap on the second end of the enclosure. The end caps are also positioned in spaced relation to the body portion of the enclose operating system.

In an embodiment, the enclosure has a textured inside surface having a plurality of adjacent cavities and protrusions. The cavities may take the form of a plurality of cavities and protrusions, which may be a plurality of adjacent slots and ridges. If the wall is fabricated from known processes such as extrusion, injection molding, pressing, blow molding or the like, the cavities can be integrally formed in the surface. Alternatively, or in addition, a plurality of strips of sound attenuating material may be affixed to and spaced apart on surface.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is an exploded view of the enclosure.

FIG. 2 is a side elevational view of the enclosure positioned over a pool pump.

FIG. 3 is an sectional view of a panel on the enclosure from FIG. 3.

FIG. 4 is a perspective view of the enclosure having an aperture positioned on an end of the enclosure.

FIG. 5 is an exploded perspective view of an embodiment of the enclosure including at least two separable members being assembled around a pool pump.

FIG. 6A is top view of the attachment of two separable members.

FIG. 6B is a top view of the attachment of two separable members.

FIG. 7 is an exploded view of the enclosure being assembled on a valve.

FIG. 8 is an exploded perspective of the end caps for assembly over a flange.

### DETAILED DESCRIPTION OF THE DRAWINGS

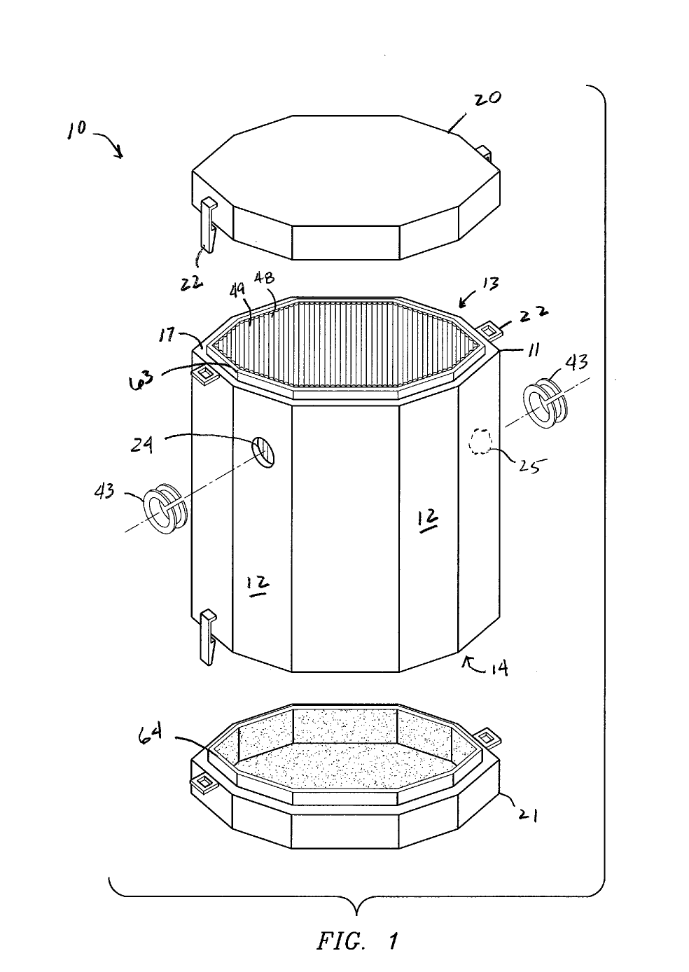

The present invention shown in FIGS. 1 and 2, for a sound attenuation enclosure 10 comprises a body 11 having one or more panels 12 arranged to form a tube-like configuration with a first open end 13 and a second open end 14. The panels 12 are aligned side by side to wherein the adjacent panels 12. Each of the panels 12 is disposed at an angle with respect to an adjacent panel 12 forming the decahedral configuration illustrated in some of figures. The invention, however, is not limited to the disclosed decahedral shape, but may include any cross-sectional configuration such as a triangle, square, heptahedral, octahedral, etc.

Positioning the panels 12 at angles with respect to one another creates a noise cancellation characteristic. The operating system within the enclosure 10 generates sound waves at different frequencies. The angled panels 12, along with the below-described textured surface creates more reflections of sound waves that will cancel each other, and breaking down the sound waves before it addresses the below-described sound retardant material. This combination of the angled panels 12 and texture surface addresses the higher frequency sound waves. The sound retardant material 19 is provided to address the lower frequencies. However, the body 11 may be circular in shape and provide sound attenuation.

A feature of an embodiment of the invention is that the body 11 and/or panels 12 are positioned in spaced relation to an operating system positioned within the enclosure. In this manner, the body 11 and/or panels 12 does not contact an operating system within the enclosure, which contact can cause failures or shorten the life of the system as a result of the operating system overheating.

In an embodiment the panels 12, or inside surfaces thereof, are spaced from a body of the operating system not less a half an inch, and typically the inside surface of the body 11 is spaced at least 1½ inches from the enclosed operating system. Accordingly, the enclosure 10 includes at least one aperture through which a part, connected to the operating system, may protrude. Such parts include, but are not limited to, electrical cables, chords or wires, piping or other parts that extend from the operating system. In the embodiment shown in FIG. 1, the enclosure includes a first aperture 24 and a second aperture 25 through which such parts may protrude.

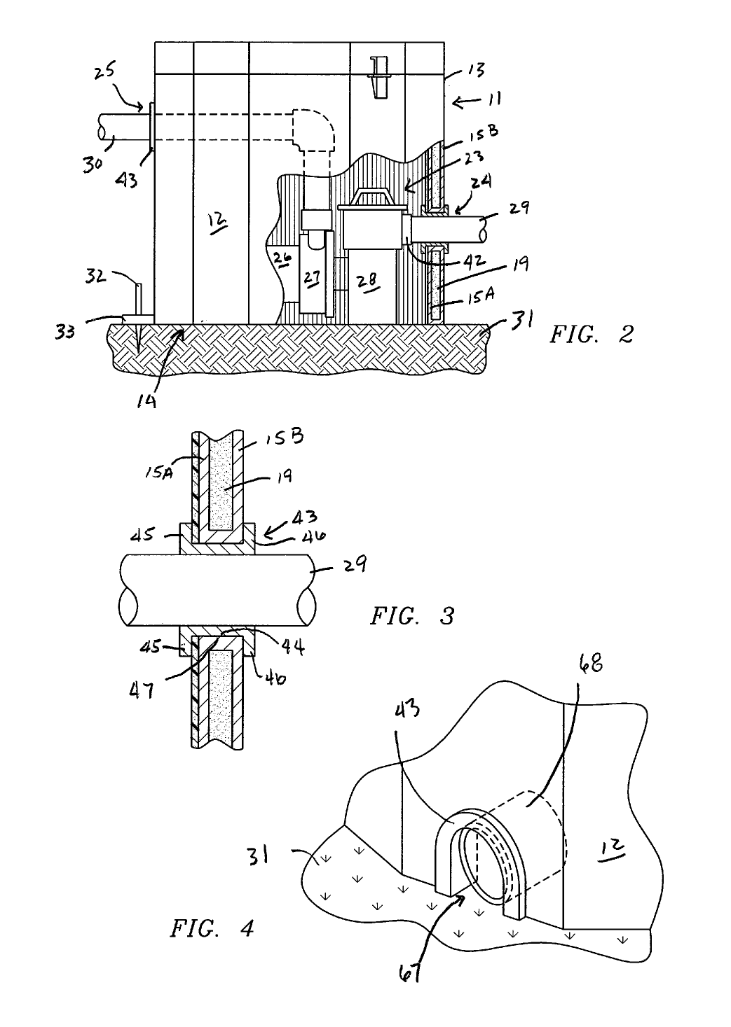

The location of the apertures 24 and 25 on the body 11 will depend on the disposition of the parts on the operating system that will protrude through the enclosure 10. Apertures may also be located on the end caps 20 and 21 as described in more detail below. As shown in FIG. 4, an aperture 67 is positioned at one of the ends 13 or 14 of the enclosure 10 to received a parts that may disposed against a surface such as a pipe 68 on the ground 31.

In an embodiment shown in FIGS. 1 and 3, the body 11 has an enclosed inner chamber 16 defined in part by an inner wall 15A and outer wall 15B. The chamber 16 is sealed at the first end 13 by rim 17 and at the second end 14 by rim 18 (shown in FIG. 7). The chamber 16 is filled with a sound retardant material 19 for sound attenuation. Various sound retardant materials are acceptable, including, but not limited to, rubber, polymer foam, water, gravel, sand, or other dense materials used for sound attenuation. In some instances, the chamber 16 may not contain the sound retardant material, and the components remain hollow. Alternatively, the body 11 may be fabricated as a solid piece of sound retardant material, and not have a chamber 16.

In addition, in order to better attenuate sound an inside surface of the body 11 is textured to create a series of cavities and protrusions. As shown in FIG. 1, a series of adjacent elongated slots 48 and ridges 49 are formed on the wall 12, and may be formed as an integral part of the wall 12 during fabrication as in extrusion. Alternatively, or in addition, a plurality of strips of sound attenuating material, such as acoustic foam may be affixed to an inside surface of the body 11 and spaced apart to form the series of slots and ridges. This type of textured surface creates viscous losses as sound pressure waves move in and out of the cavities

The body 11, and some or all of the other components described herein, are preferably fabricated from extrusion of known materials including aluminum, steel, rubber (neoprene, polyisoprene, natural rubber, polyurethane, viton, nitrile, silicon etc.) or a plastic material (polyvinylchloride, polyethylene, polystyrene, nylon etc.). However, other methods such as blow molding, slip casting, pressing and injection molding and materials used with such methods may be used to practice the disclosed invention. The materials selected will depend on various parameters such as the method of manufacture, the size of enclosure 10 and the level of sound attenuation desired.

In addition, all components described in each of the embodiments may be designed so that the enclosure, including its components, is transportable to and assembled at a desired site. If necessary, the enclosure can be disassembled, and the components moved to another site or stored. The enclosure 10 and its components may range in dimensions depending on the nature of the device to be covered. The enclosure 10 may have an inside diameter of about eighteen inches, but the inside diameter may be larger or smaller depending on the application. In addition, depending on the application the panels 12 may have a thickness ranging from about 11 mm to about 15 mm. If the body 11 has an enclosed chamber, the chamber 16 will range in thickness from about 7 mm to about 9 mm; and, the inner wall 15A and outer wall 15B may have a thickness ranging from 2 mm to about 3 mm. The enclosure 10 can be used to cover smaller household devices such as pool pumps, sump pumps, well pumps and oil furnace pumps or smaller industrial applications such as valves, portable generators or any other items that generate sound at an unacceptable noise level.

Depending on its application, and as shown in FIGS. 1 and 2, the enclosure 10 may include one or more end caps 20 and 21. The embodiment illustrated includes a first end cap 20 for covering the first end 13 of the enclosure 10 and a second end cap 21 for covering the second end 14 of the enclosure 10. The end caps 20 and 21 may be secured to the enclosure using conventional fastening means such as the illustrated clips 22. The end caps 20 and 21 and the ends 13 and 14 of the enclosure may be threaded to screw the caps 20 and 21 on the enclosure 10; or, the end caps 20 and 21 and enclosure 10 may be dimensioned so the end caps 20 and 21 fit snugly on the enclosure without the need for a fastening system. The end caps 20 and 21 are positioned on the ends 13 and 14 so that the end caps 20 and 21, similar to the body 11, are positioned in spaced relation to an operating system within the enclosure.

With respect to FIG. 2, the enclosure 10 surrounds a pool pump 23. The pool pump 23 includes a motor 26 operably connected to a pump 27, which draws water via inlet conduit 29 through a filter 28. The water is returned to a pool (not shown) via outlet conduit 30. The conduits 29 and 30 are connected to the pool pump 23 via fittings 42 and 43. The inlet conduit 29 extends through the first aperture 24 formed in the wall 12 of the enclosure 10. The outlet conduit 30 extends through the second aperture 25 formed in the wall 12 of the enclosure 10.

Grommets 43 are disposed within the apertures 24 and 25 between an edge of the apertures 24 and 25 and the conduits 29 and 30 sealing the interface between the enclosure 10 and the conduits 29 and 30. As shown in FIG. 3, the grommet 43 has a ring 44 that seats flush against and edge 24A and 25A of the apertures 24 and 25. In addition the grommet 43 includes a first flange 45 and a second flange 46 that is spaced laterally with respect to a first flange 45 forming a channel 47 there between within which an edge 24A of the aperture seats.

An end cap, which can be characterized as either the first end cap 20 or second end cap 21 is positioned on an open end 13 or 14 of the enclosure 10. For convenience in describing the invention, the first end cap 20 is secured to the first end 13 of the enclosure 10 above the pool pump 23, and the second end 14 is disposed on the ground 31. In this case, where the second end 14 is disposed on the ground 31 the enclosure 10 includes only one end cap 20. Spikes 32 inserted through tabs 33, which are attached to the second end 14 of the enclosure 10, and into the ground 31, secure the enclosure 10 to the ground 31.

The enclosure 10, and the apertures 24 and 25, may be engineered so that the enclosure 10 matches the positions of inlet or outlet parts of a particular brand of operating system. More specifically, the apertures 24 and 25 are positioned on the wall 12 so the apertures 24 and 25 will align with the plumbing associated with the pump 27 and filter 28. In this manner, the enclosure 10 can be sold with the pool pump 23 and installed during the installation of the pool pump 23.

In the embodiment shown FIGS. 1, 2 and 3, the body 11, and/or panels 12 forming the body 11, is a single integral component. After the pool pump 23 is installed and before the conduits 29 and 39 are mounted to the pump 27 and filter 28, the enclosure 10 is placed over the pump 23, without the end cap 20 attached. The apertures 24 and 25 are aligned with fittings 42 and 43 on the pool pump 23. The conduits 29 and 30 are then inserted through apertures 24 and 25 and secured to fittings 42 and 43. In as much as the end cap 20 has not been installed, one can access the pool pump 23 through the first end 13 of the enclosure 10 to secure the conduits 29 and 30 to the pump 27 and filter 28.

In some instances, the conduits 29 and 30 may not be properly aligned as a result of the customization of the plumbing associated with the installation of the pool pump 23. In such a case, extra fittings or piping, for example flexible PVC piping, can be incorporated to connect the conduits 29 and 30 to the pool pump 23.

The enclosure 10 may also be provided without apertures 24 and 25; the enclosure 10 and pool pump 23 may be retrofitted as necessary so the conduits 29 and 30 can be connected to pool pump 23. More specifically, the location of the apertures 24 and 25 on the enclosure 10 are measured or calculated with respect to the position of the conduits 29 and 30. The apertures 24 and 25 are then cut or drilled through body 11. The enclosure 10 is placed over the pool pump 23, and the conduits 29 and 30 are attached or reattached to the pool pump 23. The first opened end 13 provides access to the interior of the enclosure 10 to secure the conduits 29 and 30 in place. If the pool pump 23 and conduits have been previously installed, then the pool pump 23 is partially disassembled by detaching the conduits 29 and 30, which are reattached after the enclosure 10 is secured in place. The grommets 43 preferably have a small slit so the grommets 43 can be opened to fit around the conduits 29 and 30 and inserted into the apertures 24 and 25.

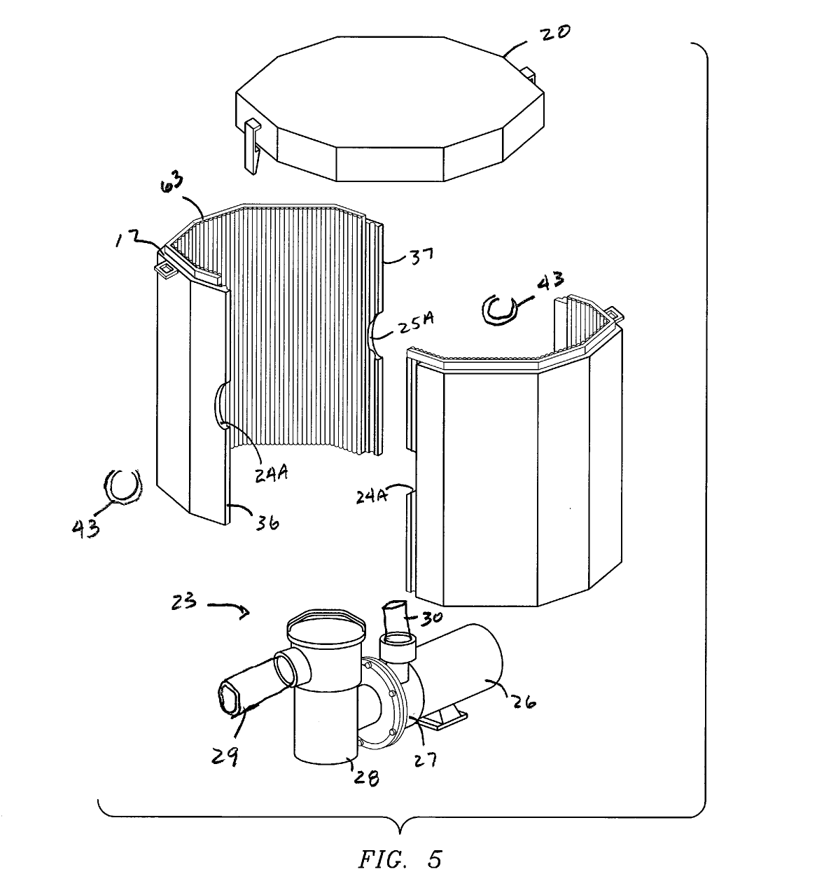

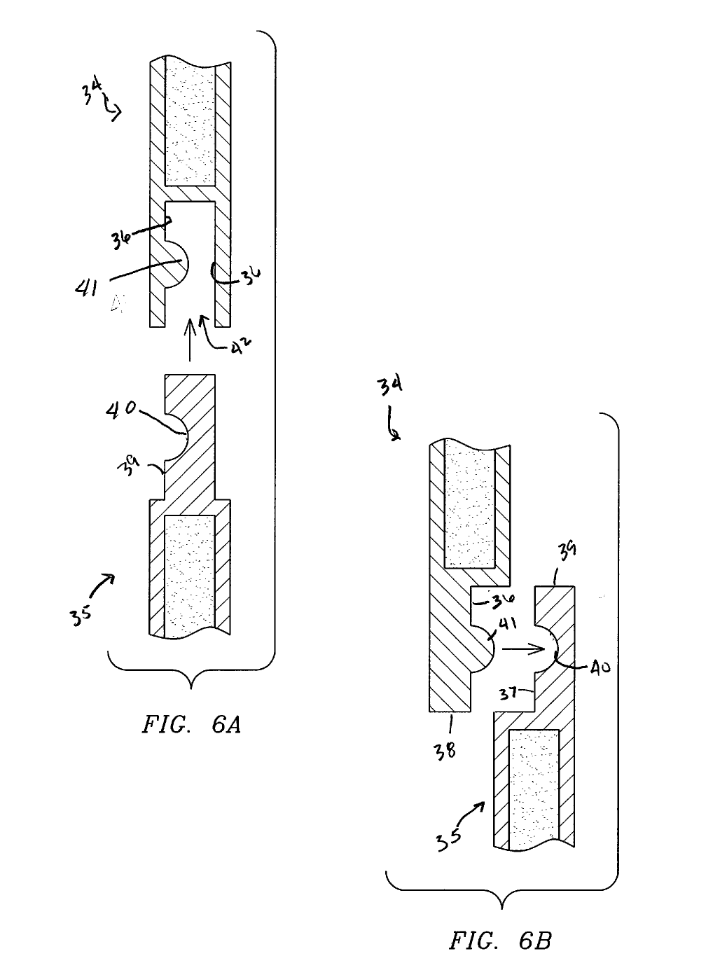

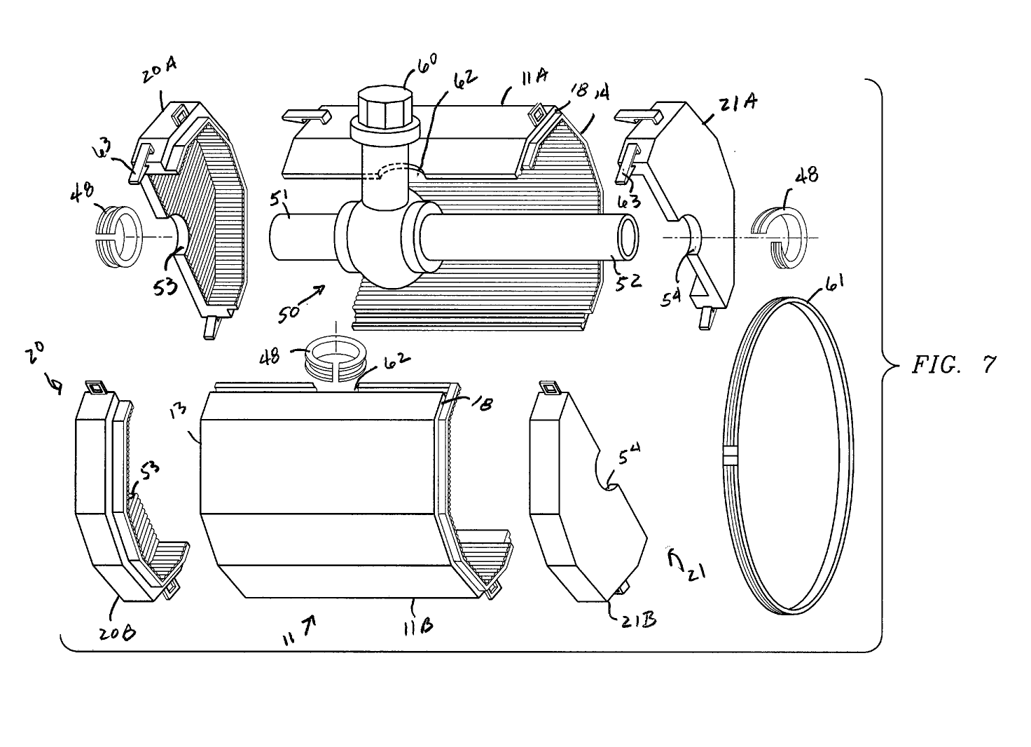

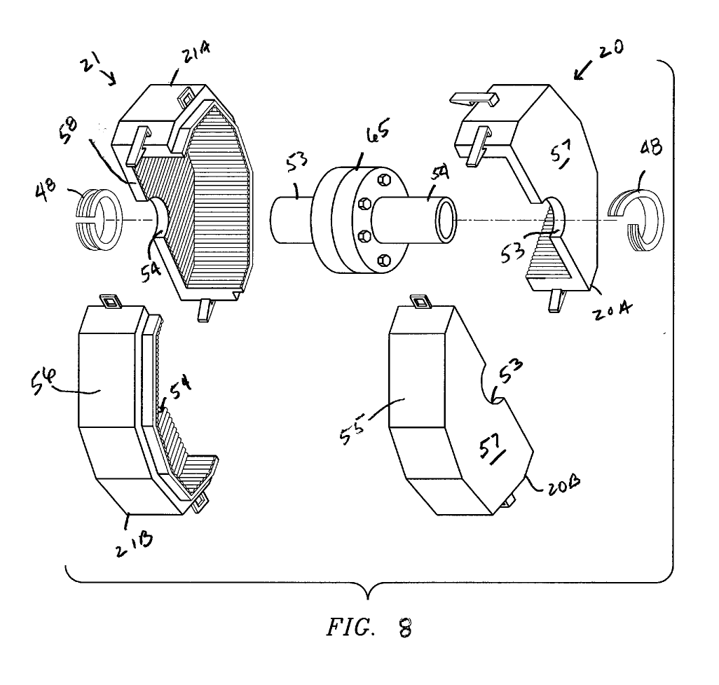

As shown in FIG. 5, the body 11 may include two separable members 34 and 35 that can be detachably secured to one another to surround the pool pump 23, or other operating system. The apertures 24 and 25 are positioned on the wall 12 along the line of attachment of the members 34 and 35 so the apertures are divided into two indentations 24A and 25A along respective edges 36 and 37 of the members 34 and 35. When the members 34 and 35 are secured together apertures 24 and 25 are formed. As shown in FIG. 5, the enclosure can be assembled without first detaching the conduits 29 and 30 from the pool pump 23. The members 34 and 35 are placed in position next to the pool pump 23, and indentations 34A and 35A are aligned with conduits 29 and 30. The members 34 and 35 are then secured together in a manner as described below with respect to FIG. 6A.

When the members 34 and 35 are secured together a gap exists between an edge 24A and 25A of the apertures 24 and 25 and the conduits 29 and 30. The grommet 43 is inserted in the gap between the edge 24A or 25A and conduits 24 and 25. The grommet 43 has a similar configuration as previously described grommet 43 except the grommet 48 has a small slit between ends 43A and 43B. In this manner, the ends 43A and 43B are separated so the grommet 43 is opened, wrapped around the conduits 29 and 30 and inserted into the apertures 24 and 25. Accordingly, the interface between enclosure 10 and conduits 29 and 30 is sealed.

With respect to FIG. 6B, the members 34 and 35 each have a lip 36 and 37 on respective edges 38 and 39, so the members 34 and 35 can be secured in mating relationship. In addition, lip 37 has a female notch 40 for receiving protrusion 41 (on lip 36) to align the first member 34 with respect to the second member 35, and secure the components together. Additional, fastening means, for example plastic tie wraps, clasps or latches mounted to the members, bungee chords or the like may be used to secure the members 34 and 35 together. As shown in FIG. 6A, one of the members 34 or 35 may have two lips 36 forming groove 42 within which lip 37 is inserted. The two lips 38 are sufficiently resilient to open for receiving the lip 37 with notches 41, and hold the two members 34 and 35 together without the need of additional fasteners although, such fasteners could be used if necessary or desired.

In some instances parts of an operating system may protrude through the end caps 20 or 21, in which case the end caps 20 or 21 will have at least one aperture. The end caps 20 and 21 may be formed as an integral part as shown in FIG. 1, or separated into one or more members as shown in FIG. 7. While the previously described embodiments illustrate the enclosure 10 vertically disposed, the enclosure 10 may be disposed at any angle relative to a vertical longitudinal axis of the enclosure 10. In the event that the enclosure 10 is used to attenuate sound of an existing, or previously installed system, the enclosure 10 is assembled as shown in FIG. 7. In this embodiment, the longitudinal axis of the enclosure 10 is disposed horizontally so the enclosure may abate sound emanating from a valve body 50.

Pipes 51 and 52 are in fluid communication with the valve body 50 and enter the enclosure 10 through apertures, which are formed in the first end cap 20 and second end cap 21 respectively. In addition, a regulator 60 extends through an aperture formed in the body 11 of the enclosure 10

As shown in FIG. 7, the enclosure 10 is divided into six separable components. The first end cap 20 includes a first member 20A and a second member 20B; and, the second end cap 21 includes a first member 21A and second member 21B. Similarly, the body 11 includes a first member 11A and second member 11B. As assembled the end cap 20 will have an aperture through which pipe 51 extends, so each of the first member 20A and the second member 20B has an indentation 53 to form the aperture. Similarly, as assembled the end cap 21 has an aperture through which pipe 52 extends so each of the first member 21A and second member 21B has an indentation 54 to form the aperture. In addition, as assembled the body 11 has an aperture through which the regulator 60 extends, so the first member 11A and the second member each have an indention 62 to form the aperture.

The enclosure 10 is assembled by securing the first member 11A and second member 11B in abutting relationship with each other and about the valve body 50. The members 11A and 11B are secured together using various known fastening systems such as the tie wrap 61 shown in FIG. 7; however, other fastening systems as described above may be used. Then the end caps 20 and 21 are secured to the respective ends 13 and 14 of the enclosure 10. The members 20A and 20B are positioned around the pipe 51, secured together and then secured to the first end 13 of the enclosure 10. The members 21A and 21B are attached to the second end 14 in a similar fashion. As illustrated in FIG. 7, fasteners 63 may be positioned on a top surface or side of the end caps 20 and 21 to fasten to together the members 20A and 20B, and fasten together members 21A and 21B.

The grommet 48 is preferably disposed in each of the apertures between the pipes 51 and 52, regulator 60 and the body 11 of the enclosure 10. The grommet 48 is installed in a similar fashion as described above with respect to pool pump 23 and conduits 29 and 30 to provide a seal at the respective interfaces. In this manner the end caps 20 and 21 support the enclosure 10 and wall 12 on the pipes 51 so the wall 12 is fixed in space relation to the valve body 50. It is noted that although the embodiment has been discussed using the components divided into two or more members, the enclosure 10 may also incorporate previously described integral components when the enclosure 10 is installed during installation of the valve body 50 and pipes 51.

With respect to FIG. 1, the body 11, and the end caps 20 and 20 are preferably configured so that the body 11 and the end caps 20 and 21 are secured together in mating relationship. More specifically, the first end 13 of the body 11 has a lip 63 that has a diameter less than an inside diameter of the first end cap 20 for receiving the end cap 20 on the body 11. In addition, the second end cap 21 has a lip 64 that has an diameter less than an inside diameter of the second end 14 of the body 11 and wall 12 for receiving the end cap 21 on the body 11.

In this manner, the components are interchangeable. For example, the ends 20 and 21 may be combined to form the enclosure 10 without the body 11 as shown in FIG. 9. In this embodiment, the end caps 20 and 21 are secured together to cover a flange 65 disposed on pipes 53 and 54. The end caps 20 and 21 are divided into their first and second members 20A, 20B, 21A and 21B, and assembled about the flange 65 as illustrated. The indentations 53 and 54 form the apertures in the end caps 20 and 21 through which the pipes 53 and 54 extend. The first end cap 20 has an annularly extending side 55; and second end cap 21 has an annularly extending side 56, which for the body of the enclosure 10 when juxtaposed over the flange 52. In addition, the top sides 57 and 58 further encase the flange 52 within the enclosure as the end caps 20 and 21 do in other described embodiments. The end caps 20 and 21 are preferably dimensioned sufficient in depth and inside diameter so an interior surface of the end caps 20 and 21 is fixed in space relation with respect to the flange 52.

The above-described invention including the separable components provides a sound attenuating enclosure that is transportable and highly adaptable for a desired application. The enclosure may be fabricated so its components do not have apertures so that the enclosure can be adapted on site to retrofit an existing operating system. Alternatively, the enclosure can be engineered so that all the components, including placement of apertures with respect to parts of an operating system, are designed to fit a particular brand of an operating system.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What I claim as my invention is:

1. An enclosure for attenuating sound emanating from an operating mechanical or electro-mechanical system having an operating body portion generating the sound and at least one input or output part, the enclosure comprising:
a body portion having a plurality of panels aligned side by side wherein each panel is abutting, and positioned at an angle with respect to an adjacent panel forming the enclosure having a first opened end and a second opened end, and each panel is positioned in spaced relation to the body of the operating system;
at least one aperture formed in the enclosure; and,
at least one end cap positioned over either the first end or second end of the enclosure wherein the end cap is separable from the body.

2. The invention of claim 1 wherein the body has an interior surface that is lined with a plurality of adjacent cavities and protrusions.

3. The invention of claim 1 wherein the body comprises a first member attached to a second member and the first and second members are separable from one another.

4. The invention of claim 3 wherein the first member has an edge positioned in abutting relationship with an edge on the second member, an indentation on the edge of the first member is aligned with an indention on the second member forming the aperture.

5. The invention of claim 1 wherein the aperture is position on the first end or second end of the enclosure.

6. The invention of claim 1 wherein the aperture is positioned on the body.

7. The invention of claim 1 wherein the aperture is positioned on the end cap.

8. An enclosure for attenuating sound emanating from an operating mechanical or electro-mechanical system having an operating body portion generating the sound and at least one input or output part, the enclosure comprising:
a body portion formed by extrusion of a sound attenuating material having a plurality of panels aligned side by side wherein each panel is abutting and positioned at an angle with respect to an adjacent panel and the enclosure having a first opened end and a second opened end, and each panel is positioned in spaced relation to the body of the operating system;
wherein a plurality of adjacent cavities and protrusions are formed on an interior surface of the body;
at least one aperture formed in the enclosure through which the part extends; and,
at least one end cap positioned over either the first end or second end of the body wherein the end cap is separable from the sides of the body.

9. The invention of claim 8 wherein the body comprises a first member attached to a second member and the first and second members are separable from another.

10. The invention of claim 9 wherein the first member has an edge in abutting relationship with and an edge on the second member, an indentation on an edge of the first member is aligned with an indention on the second member forming the aperture.

11. The invention of claim 8 wherein the aperture is positioned on the first end or second end of the enclosure.

12. The invention of claim 8 wherein the aperture is positioned on the body.

13. An enclosure for attenuating sound emanating from mechanical or electro-mechanical system having an operating body portion, an inlet conduit connected to the body portion and an outlet conduit through which a fluid flows, and the body portion generating sound, the enclosure comprising:
a body portion configured to form an enclosure having an interior within which the operating system is disposed and the wall is positioned in spaced relation to and not touching the body of the operating system;
a first aperture through which the inlet conduit extends; and,
a second aperture through which the outlet conduit extends.

14. The invention of claim 13 wherein the enclosure has an interior surface and a plurality of adjacent cavities and ridges are on the interior surface of the enclosure.

15. The invention of claim 13 wherein the body has a first opened end and a first end cap positioned over the first opened end of the body wherein first the end cap is detachable from the body.

16. The invention of claim 16 wherein the wall has a second opened end and a second end cap positioned over the second opened end of the body, which is detachable from the body.

17. The invention of claim 16 wherein the first aperture is positioned on the first end cap.

18. The invention of claim 17 wherein the second aperture is positioned on the second end cap.

19. The invention of claim 13 wherein the wall is formed by the extrusion of a sound retardant material.

22. The invention of claim of claim 13 wherein in the body includes an enclosed inner chamber filled with a sound retardant material.

21. The invention of claim 13 wherein the body includes a plurality of panels aligned side by side wherein each panel is abutting and positioned at an angle with respect to an adjacent panel and the enclosure having a first opened end and a second opened end, and each panel is positioned in spaced relation to the body of the operating system.
